(19) United States
(12) Patent Application Publication
(10) Pub. No.: US 2006/0158440 A1
(43) Pub. Date: Jul. 20, 2006

(54) Active dynamic tactile feedback stylus

(75) Inventor: Robert Ashenbrenner, Austin, TX (US)

Correspondence Address: FORTKORT GRETHER & KELTON LLP, 9442 N. Capital of Texas Hwy., Arboretum Plaza One, Suite 500, AUSTIN, TX, 78759, US

(73) Assignee: Motion Computing Inc.

(21) Appl. No.: 11/038,615

(22) Filed: Jan. 19, 2005

(51) Int. Cl. G09G 5/00

(52) U.S. Cl. 345/179

(57) ABSTRACT

An improved system and method for user input in to a computer particularly tablet computers. The improvements involve generating tactile feedback through a stylus to a user. The feedback being dependant on what virtual function the pen is providing or where the stylus is positioned relative to the information displayed on the computer display or where the curser is in the displayed information.

### TECHNICAL FIELD

The present invention relates generally to input devices for personal computing systems and devices. More specifically, the invention relates to stylus based input devices for personal computing systems and devices

### BACKGROUND OF THE INVENTION

Motion Computing, Inc. (Motion) of Austin, Tex. has been at the forefront of new paradigms related to tablet and slate computers and their applications in organizational and personal computing. One major area of development has been with the user interface and user experience in using a tablet computer. With in the area of user interface, one particular area of development has related to the use of stylus based user input to the tablet computer's display.

One limitation of prior stylus based input devices relates to the tactile feel of the stylus during use. Typically, the stylus has a plastic tip. During use the plastic tip is placed in contact with the glass or glass-like plastic surface of the tablet computer display. This interface typically does not give the “feel” of writing on paper with a pen or pencil. Additionally, the hovering or sliding stylus provides the user with inadequate indication that the stylus has moved over a menu selection, active field or other possible target location on the display. Past efforts to provide desirable “feel” to the user have been based on the selection of materials and surface treatments of the either the stylus or the display surface or a combination of the two. Improvement to the feel of the stylus during use would be beneficial to the user of tablet computers. Additionally, feedback dependant on the informational content of the display would also be beneficial to the user of tablet computers.

### BRIEF DESCRIPTION OF THE DRAWINGS

A better understanding of the present invention can be obtained when the following detailed description of the disclosed embodiments is considered in conjunction with the following drawings, in which:

FIG. 1 illustrates an example of a stylus used with a tablet computing device;

FIG. 2 illustrates major components of an improved stylus for use in an application such as the one illustrated in FIG. 1;

FIG. 3 illustrates in greater detail an embodiment of tactile feedback generators illustrated in FIG. 2;

FIG. 4 illustrates an alternative embodiment employing the use of a solenoid tactile feedback mechanism to provide user feedback; and

FIG. 5 illustrates an alternative embodiment illustrating different placement of the tactile feedback mechanisms in the stylus;

FIG. 6 illustrates a block diagram of the electronic circuitry of the embodiment illustrated in FIG. 5;

FIG. 7 illustrates a cross-section view of a tablet computing device; and

FIG. 8 illustrates an example of informational content on a display of a typical tablet computing device to illustrate how the improved stylus can improve the user input experience.

### DETAILED DESCRIPTION OF THE FIGURES

Although described with particular reference to a tablet computing device, the claimed subject matter can be implemented in any electronic system which is designed to receive input from a stylus through direct or indirect interaction with a display. Those with skill in the computing arts will recognize that the disclosed embodiments have relevance to a wide variety of computing environments in addition to those described. In addition, portions of the system and methods of the disclosed invention can be implemented in software, hardware, or in differing combination of software and hardware. Some hardware portions can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory and recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

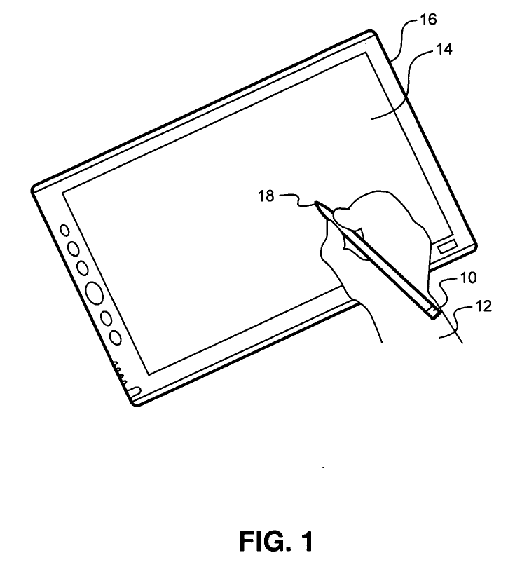

FIG. 1 illustrates an example of the operating environment of the improved stylus computer input device. It consists of the stylus 10 operated by a user 12 inputting information directly on the display 14 of a tablet computer 16. Input is typically made with a dull pointed end 18 of the stylus 10.

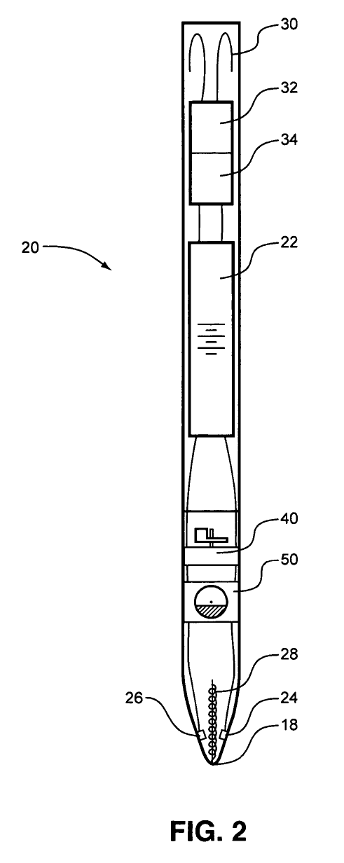

FIG. 2 illustrates of one embodiment of an improved stylus 20. The stylus is powered by a battery 22 which provides power to the active elements in the stylus 20. The stylus 20 includes electrical contacts 24 and 26. These contacts exposable to the external surface of the stylus 20 for making contact with a battery charging transformer (not shown). When the stylus 20 is either cradled in the tablet PC (not shown) or in a separate stand-alone cradle (not shown) these contacts provide a means for charging the battery 22 in the stylus. In alternative embodiments, the electrical contacts may not be exposed but rather may be covered in a fashion so that the can be exposed for charging. In other alternative embodiments, a traditional replaceable battery could be employed in place of the rechargeable battery 22. Alternatives to electrical contact recharging are available and could be employed in alternative embodiments. Because of size and electromagnetic compliance, the applicants find the physically exposed electrical contacts in combination with a conventional Lithium rechargeable battery serve the purpose well. In such an embodiment, electrical contacts 24 and 26 or other recharging mechanisms would not be necessary. However, such embodiments would require a means for allowing the removal and replacement of the battery(s).

The improved stylus also contains an antenna 30 for receiving communications from the tablet PC (not shown). The signal picked up by the antenna 30 is received by a wireless receiver circuit 32. The wireless receiver circuit 32 converts the signal picked up by the antenna 30 and converts it to data that is sent to a control circuit 34. In alternative embodiments the transmitter in the computing device and the wireless receiver in the stylus could be replaced by a hard wire connection between the computing device and the stylus. However, for freedom of movement a wireless communication system like Bluetooth would be preferable. In the case of a stylus short range Bluetooth would be suitable. However medium and longer-range blue tooth would also be suitable. Additionally, other wireless communications protocols are also available. The control circuit 34 converts the control data into signals through hard wire electrical connections (not shown) to drive transducer device(s) 40 and 50 for converting the control signals into mechanical signals/tactile feedback to the user.

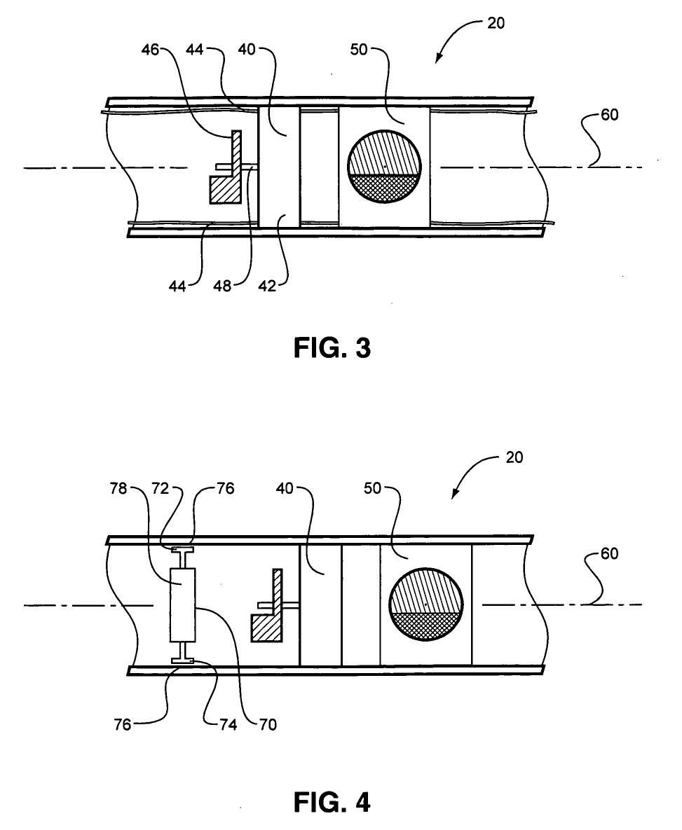

FIG. 3 illustrates in greater detail an embodiment of the transducer device(s) 40 and 50 from FIG. 2. This embodiment of the transducer device 40 is comprised of an electric motor 42 with electrical connections 44 and an off-balance flywheel 46 attached to the armature 48 of the electric motor 42. The electrical connections 44 receive the drive signals from the control circuit 34. Because the flywheel 46 is unbalanced, when the motors armature 48 spins, vibration results. The resulting vibration varies with the speed that the motor is driven. In some embodiments, the speed to which the motor is driven depends on the voltage/current that is supplied to the motor.

Since vibration is caused by spinning an off balanced flywheel 46, it is preferable that either the armature of the motor on which the flywheel is mounted be dampened. The function of the dampening is to decrease the hysteresis or latency of the vibratory effect after the electrical signal is changed or shut off. In other words, the dampening decreases the time the device continues to vibrate after the control circuit stops sending a drive signaling to rotate the motors. In an alternative embodiment the rotation of the flywheel itself might be dampened.

The embodiment illustrated in FIG. 3 contains two vibratory transducers 40 and 50. The transducers 40 and 50 are oriented so that the flywheels lie in different planes. In the embodiment shown, one of the vibratory transducers 40 has a flywheel that lies in a plane that crosses the centerline 60 of the stylus 20. The flywheel of the other vibratory transducer 50 lies in a plane that either contains the centerline 60 of the stylus 20 or is generally parallel to the centerline 60 of the stylus 20. Each of these vibratory transducers provides a vibratory sensation that provides a different tactile sensation to the user. In other embodiments a single such transducer may be used. Such single transducer could be used in either of the orientations illustrated in FIG. 3 or in any other orientation. Muli-transducer embodiments could also use orientations in addition to, or in substitution of, the orientations illustrated in FIG. 3.

FIG. 4 illustrates an alternative embodiment of an improved stylus 20. This embodiment illustrates a solenoid transducer 70. This transducer 70 causes a click when activated by extending a solenoid 72 (or solenoids 72 and 74) to the inner surface 76 of the stylus from the body 78 of the solenoid 70. This solenoid transducer 70 can be controlled to provide a single click. The solenoid transducer can also be controlled to provide a series of clicks. If these series of clicks are provided at a sufficiently fast frequency they provide a vibratory effect.

Although FIG. 4 illustrates a single solenoid/clicker transducer 70, other embodiments could employ multiple such transducers. Similarly, other embodiments of the invention employ multiple types of transducers. The embodiment illustrated in FIG. 4 contains two different types of transducers: a solenoid transducer 70 and two off balance flywheel transducers 40 and 50. Other combinations and other types of transducers are all possible and within the spirit of the present invention.

In FIG. 4 the solenoid transducer 70 is oriented so that the solenoids 72 and 74 travel in a line perpendicular to the center line 60 of the stylus 20. Any other orientations are possible in other embodiments. Similarly, any combinations of orientations for multiple transducers are also possible.

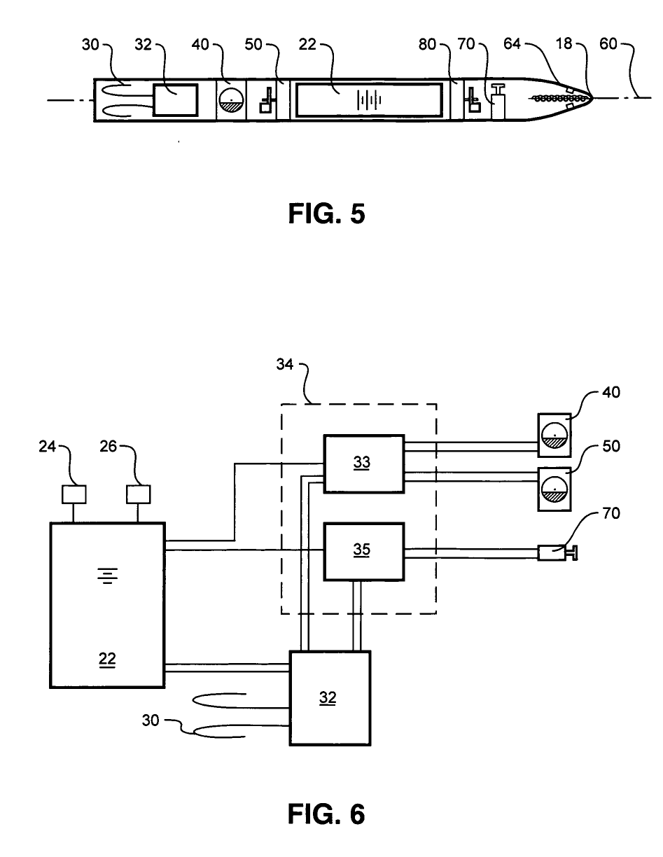

FIG. 5 illustrates an alternative embodiment of the invention. In this embodiment, the transducers 40, 50, 80 and 70 are located in different locations in the stylus 20. In the embodiment illustrated in FIG. 2, the transducers were placed in the stylus 20 generally proximate to the location where the user holds the stylus 20. The embodiment illustrated in FIG. 5 has transducers spaced differently along the centerline 60. For example, in this embodiment two transducers 40 and 50 are located near the top 62 of the stylus 20 and two transducers 70 and 80 are located near the bottom 64 end of the stylus 20. In other embodiments, the transducer may be in other locations of the stylus 20 or in different spacing patterns. The purpose of these differing locations and orientations is to provide noticeably different tactile feedback to the user. This difference may or may not be on the conscious level of the user. The user may or may not be consciously aware of the difference in feedback. The benefits of the difference may have to be learned by use or repetition.

FIG. 6 illustrates a block diagram of the electronic circuitry in the improved stylus. A rechargeable battery 22, previously described, powers the circuitry. The rechargeable battery 22 is recharged through electrical contacts 24 and 26 which are exposable to the outer surface of the stylus. The battery supplies power to the wireless receiver circuitry 32 and to the transducer device driver(s) 34. An antenna 30, attached to the wireless receiver 32, receives signals from the computing device with which the stylus is functioning. The wireless receiver 32 converts this information into data that can be used by the device drivers 33 and 35 which convert the data into signal(s) to drive the transducer device(s) 40, 50 and 70. In the embodiment shown, there are two different transducer device drivers 33 and 35. One of the drivers 33 is a motor driver which drives two electric motor based transducers 40 and 50. The second driver 35 drives a solenoid-based transducer 70. In alternative embodiments, a single driver could drive all of the transducers even if they are of differing types. These drivers could simply be amplifiers that amplify the signal received by the antenna from the computer. In alternative embodiments, the drivers could drive the transducers in a predefined manner if the receiver circuit 32 receives any recognized signal.

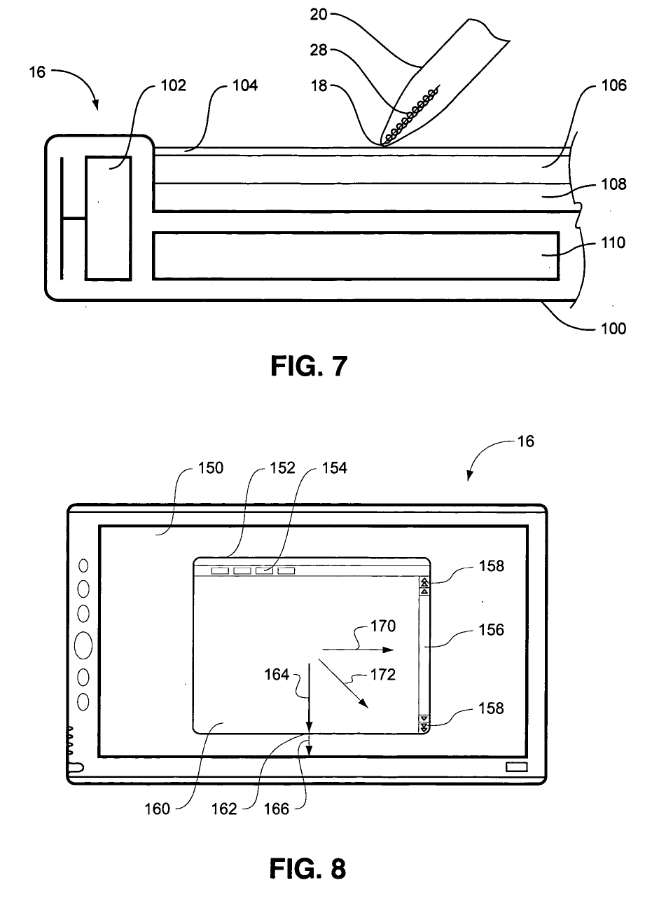

FIG. 7 illustrates a typical computing device 100 for receiving input from a stylus 20 that can send tactile feedback signals to the improved stylus 20. The computing device 100 includes a wireless communications transmitter 102 that sends signals to be received by the stylus antenna/receiver (not shown in this figure). The computing device also includes a display with a protective top layer 104, a light generating layer 106, and a digitizer layer 108. The light-generating layer 106 generates the graphical information viewed by the user. The digitizer 108 tracks the movement of the stylus relative to the display surface 104. In this case, the stylus device 20 includes elements 28 that the digitizer 108 is able to detect when it comes close to or contacts the protective top layer 104.

Different styluses, digitizers and software of this type are widely available. For example, the pen digitizer software combination on some of these systems is able to sense differing levels of pressure being applied by the user. This information can be used to determine the thickness of the written line entered by the user. This information can also provide information used to modify the tactile feedback to the user. For example more pressure may result in more vibration while light presser may provide greater vibration. Similarly speed of movement maybe used to vary the level of vibratory effect for example as speed increases the vibration may increase to a point and then as speed continues to increase the vibratory effect may begin to decrease.

The digitizer may also be in the form of a touch-screen device such as those that are common with personal digital assistants PDAs.

FIG. 8 illustrates a practical example of one embodiment of the invention. The display area 150 is the visual interface of the computing device 16 with the user. The example illustrated in FIG. 8 is of the display in a landscape configuration. FIG. 8 illustrates a typical example of a graphical display showing an application window 152 with virtual tool buttons 154 at the top and a virtual scroll bar 156 at the right with virtual jump buttons 158 at both ends of the scroll bar to jump to the beginning and end of a document. All of these areas can be considered different virtual tool buttons or areas on the display that serve as virtual inputs buttons that may work in conjunction with In the prior art, users have been provided with visual and sometimes audio feedback when changes are made.

The tactile feedback provided to the user may be made dependant on where the user has the stylus positioned on the display. For example, if the stylus begins within the application window 160 (like a word processing document) and moves down the display along line 164 a tactile feedback transducer provides tactile feedback to the user to indicate that the user is writing on a paper document. As the pen continues along the line 166 a tactile feedback transducer provides tactile feedback that feels different than the feedback provided while the stylus is still in the application window 160. In this way, the tactile feedback stylus can provide the user with different feedback dependent on the active field in which it is operating.

In addition to field type or location dependant tactile feedback, tactile feedback provided by the stylus can depend on the speed with which the user is moving the stylus and the pressure that the user is applying on the display with the stylus.

In addition, the direction of the motion of the stylus may also be used to modify the tactile feedback provided by the stylus. For example, traveling vertically along line 164 may provide one quality of tactile feedback while traveling horizontally along line 170 may provide a different quality of tactile feedback.

Another tactile feedback may be provided when the stylus crosses a window border like the border 162 of the application window 160 between lines 164 inside the application window and 166 outside the application window. For example the level of vibration might suddenly increase and then decrease. In an embodiment employing a solenoid feedback transducer, the tactile feedback could be a click to the user signaling that a boundary has been crossed. A similar tactile feedback could be provided when the stylus crosses a tool button 154 boundary.

Some locations on the display, such as within a tool button, may cause the pen to provide tactile feedback without moving the stylus. In other cases, the tactile feedback may depend on whether a tool button 154 has been selected or entered.

In other embodiments, feedback could be provided to the stylus regardless of where the stylus is relative to the computing devices display. For example the user may want to configure the stylus so that it will vibrate when the computing device reminds the user of an upcoming meeting or an incoming call or email or completion of a print job or any other event for which the user desires to be notified.

In the preferred embodiment a software driver will have to be installed or have been preinstalled in the computing devices. The particulars of the software driver depend on the number and kind of transducer devices, and the number and kind of transducer device drivers, and the transmitter and receiver devices used (if any) and the functionalities described above that are desired and the level of configurability desired for the user. It is well within the skill of a software driver engineer to create a suitable driver to drive the active dynamic feedback stylus with the functionalities described above.

Additionally, it should be appreciated that many variations of tactile feedback are possible with the tactile stylus described herein and that variations on how to use the tactile feedback are as varied as the applications with which the tactile feedback stylus are used.

While the invention has been shown and described with reference to particular embodiments thereof, it will be understood by those skilled in the art, that the foregoing and other changes in form and detail may be made therein without departing from the spirit and scope of the invention, including but not limited to additional, less or modified elements and/or additional, less or modified blocks performed in the same or a different order.

I claim:

1. An active dynamic stylus for input into a computer comprising:
a) a stylus which can serve as a pointing device for the computer;
b) a receiver connected to the stylus for receiving electromagnetic signals from the computer device;
c) a transducer connected to the stylus and the receiver for converting the electromagnetic signals into mechanical signals detectible by a user holding the stylus.

2. The active dynamic stylus of claim 1 wherein the receiver receives the electromagnetic signals over hard wire.

3. The active dynamic stylus of claim 1 wherein:
a) the receiver is a wireless receiver for receiving electromagnetic signals transmitted wirelessly from the computer device; and
b) a battery is electrically connected to provide power to the receiver and the transducers connected to the stylus.

4. The active dynamic stylus of claim 1 wherein the stylus receives a signal to generate a mechanical signal when the computer device receives a signals from a sensing device that senses movement of the stylus thus providing feedback to the user in the form of a mechanical signal that the stylus is moving.

5. The active dynamic stylus of claim 1 wherein the stylus receives a signal to generate a mechanical signal when the pointing device crosses a virtual window border.

6. The active dynamic stylus of claim 1 wherein the stylus receives a signal to generate a mechanical signal when the pointing device crosses a virtual tool button.

7. The active dynamic stylus of claim 1 wherein the stylus receives a signal to generate a mechanical signal when the pointing device remains within the boundaries of a virtual tool button.

8. A computer system with a stylus based pointing input device comprising:
a) a computing device comprising:
an active display for receiving input from a stylus input device, and a transmitter for transmitting electro magnetic signals; and
b) an active stylus comprising:
a stylus which can serve as a pointing device for the computer,
a receiver receiving electromagnetic signals from the computing device, and
a transducer transforming the electromagnetic signal into a mechanical signal detectable by the user of the computer system holding the stylus.

9. The computer system of claim 8 wherein the computer transmitter transmits over hardwire and the receiver receives the electromagnetic signals over hard wire.

10. The computer system of claim 8 wherein:
a) the computer transmitter is a wireless transmitter;
b) the stylus receiver is a wireless receiver and the mechanical signals generated in by the transducers result from wireless signals sent by the computer transmitter and received by the stylus receiver,
c) the stylus is connected to a battery which is electrically connected to provide power to the receiver and the transducers connected to the stylus.

11. The computer system of claim 8 wherein the computer transmitter sends a signal which the stylus receives and responsively generates a mechanical signal when the computer device receives a signals from a sensing device that senses movement of the stylus thus providing feedback to the user in the form of a mechanical signal that the stylus is moving.

12. The computer system of claim 8 wherein the computer transmitter transmits and the stylus receiver receives a signal to generate a mechanical signal when the pointing device crosses a virtual window border.

13. The computer system of claim 8 wherein the computer transmitter transmits and the stylus receiver receives a signal to generate a mechanical signal when the pointing device crosses a virtual tool button.

14. The computer system of claim 8 wherein the computer transmitter transmits and the stylus receiver receives a signal to generate a mechanical signal when the pointing device remains in a virtual tool button.

15. A tablet computer system with a stylus based pointing input device comprising:
a) a tablet computing device comprising:
an active display capable of receiving input from a stylus input device, and
a wireless transmitter capable of transmitting electro magnetic signals over a short distance; and
b) an active stylus comprising:
a stylus which can serve as a pointing device for the tablet computer
a wireless receiver receiving electromagnetic signals from the tablet computing device, and
a plurality of transducers for transforming the electromagnetic signal into a mechanical signal detectable by the user of the tablet computer system holding the stylus.

16. The tablet computing device of claim 15 wherein characteristics of the mechanical signal generated by the stylus when the stylus moves across the active display is dependent of the direction of movement of the stylus.

17. The tablet computing device of claim 15 wherein the characteristics of the mechanical signal generated by the stylus when the stylus moves depends on the force of the stylus on the tablet display.

18. The tablet computing device of claim 15 wherein the characteristics of the mechanical signal generated by the stylus depends on the speed of movement of the stylus on the tablet display.

19. The tablet computing device of claim 15 wherein a mechanical signal can be generated by the stylus regardless of it position on or proximate to the tablet computer display.
